(19) United States
(12) Patent Application Publication
(10) Pub. No.: US 2011/0280116 A1
(43) Pub. Date: Nov. 17, 2011

(54) OPTICAL RECORDING MEDIUM AND OPTICAL RECORDING METHOD

(76) Inventors: Shuji Tsukamoto, Tokyo (JP); Hiroyasu Inoue, Tokyo (JP)

(21) Appl. No.: 13/105,388

(22) Filed: May 11, 2011

(30) Foreign Application Priority Data
May 13, 2010 (JP) 2010-110825

(51) Int. Cl. G11B 7/00; G11B 7/243

(52) U.S. Cl. 369/100; 428/64.4; G9B/7

(57) ABSTRACT

An optical recording medium having a good power margin property during recording and good jitter during reading is provided. In an optical recording medium, a Ti recording layer that includes Ti as a main component and Al as an addition component and a first Si recording layer that is arranged adjacent to a cover layer side of the Ti recording layer and includes Si as a main component are stacked between a substrate and the cover layer.

### BACKGROUND OF THE INVENTION

1. Field of the Invention

The present invention relates to an optical recording medium and an optical recording method for recording information on such an optical recording medium, and in particular, to a technology for improving a signal quality when recording information.

2. Description of the Related Art

Conventionally, optical recording media such as CDs, DVDs, and Blu-Ray Discs (BD) have been widely utilized to view digital moving image contents and to record digital data. Among these, BD, which is one of the next-generation DVD standards, utilizes the shortened wavelength of 405 nm for the laser light used in recording and reading, and the objective lens with the numerical aperture of 0.85. An optical recording medium side compliant with the BD standard is capable of recording and reading 25 GB or more per information recording layer.

Types of such recording media include write-once recording media and rewritable recording media. Write-once recording media have a function which allows information to be written onto their recording layer only once. Examples thereof include standards such as CD-R, DVD +/−R, Photo CD, and BD-R. Rewritable recording media have a function which allows information to be repeatedly written onto their recording layer. Examples thereof include standards such as CD-RW, DVD +/−RW, DVD-RAM, and BD-RE.

Not only is there a need for an improvement in the recording properties of write-once recording media, but write-once recording media also need to be made durable enough so that the initial recorded information can be maintained for a long duration without deteriorating. Further, with the recent increasing awareness about global environmental problems, write-once recording media also need to be formed using constituent materials that have a low impact on the environment.

Accordingly, for example, Japanese Patent Application Laid-Open No. 2004-284242 proposes a technology in which the recording layer of a write-once optical recording medium is formed from a material that uses an alloy of Ti and Al as a main component.

However, if the conventional optical recording medium described in Japanese Patent Application Laid-Open No. 2004-284242 is applied in a standard such as the BD standard, the jitter and power margin when recording information on the recording layer can be insufficient. Consequently, there is the problem that the recording power of the laser has to be controlled with a high degree of precision even on the optical pickup side.

### SUMMARY OF THE INVENTION

The present invention was made in view of the above-described problem. Accordingly, it is an object of the present invention to provide an optical recording medium having improved jitter during reading and an improved recording power margin property.

As a result of the diligent research performed by the present inventors, the above object is achieved on the basis of the following means.

Specifically, the present invention for achieving the above object is an optical recording medium including: a substrate; a cover layer; a Ti recording layer that is arranged between the substrate and the cover layer and includes Ti as a main component and Al as an addition component; and a first Si recording layer that is arranged adjacent to the cover layer side of the Ti recording layer and includes Si as a main component.

In the optical recording medium for achieving the above object according to the above invention, the first Si recording layer has a thickness T1 that is set to 4 nm≦T1≦5 nm.

The optical recording medium for achieving the above object according to the above invention further includes a second Si recording layer that is arranged adjacent to the substrate side of the Ti recording layer and includes Si as a main component.

In the optical recording medium for achieving the above object according to the above invention, the second Si recording layer has a thickness T2 that is set to 1 nm≦T2≦3 nm.

In the optical recording medium for achieving the above object according to the above invention, the thickness T2 of the second Si recording layer is set to be smaller than the thickness T1 of the first Si recording layer.

The optical recording medium for achieving the above object according to the above invention further including a first dielectric layer that is arranged adjacent to the cover layer side of the first Si recording layer, and a second dielectric layer that is arranged adjacent to the substrate side of the second Si recording layer.

The present invention for achieving the above object is also an optical recording method for recording information by irradiating a laser beam on an optical recording medium having a substrate, a cover layer, and an information recording layer between the substrate and the cover layer, the method including: providing, as the information recording layer, a Ti recording layer that includes Ti as a main component and Al as an addition component, and a first Si recording layer that is arranged adjacent to the cover layer side of the Ti recording layer and includes Si as a main component; and chemically or physically modifying the Ti recording layer and the first Si recording layer simultaneously by heat from the laser beam.

In the optical recording method for achieving the above object according to the above invention, the information recording layer further includes a second Si recording layer that is arranged adjacent to the substrate side of the Ti recording layer and includes Si as a main component, and the Ti recording layer, the first Si recording layer, and the second Si recording layer are chemically or physically modified simultaneously by heat from the laser beam.

According to the present invention, an optical recording medium can be provided that has an excellent power margin property while also maintaining a high level of signal quality, such as bottom jitter, during reading.

### BRIEF DESCRIPTION OF THE DRAWINGS

FIG. 1 is a block diagram illustrating an optical recording medium according to a first embodiment of the present invention and the whole configuration of an optical pickup used in recording and reading performed by such optical recording medium;

FIG. 2 is a cross sectional view illustrating a layer structure of this optical recording medium;

FIG. 3 is a diagram illustrating the reflectivity of an unrecorded optical recording medium according to a first verification example;

FIG. 4 is a diagram illustrating a degree of modulation during optimum recording power Po for the optical recording medium according to the first verification example;

FIG. 5 is a diagram illustrating a minimum value of LEQ jitter (bottom jitter) of the optical recording medium according to the first verification example;

FIG. 6 is a diagram illustrating a power margin of the optical recording medium according to the first verification example;

FIG. 7 is a cross sectional view illustrating a layer structure of an optical recording medium according to a second embodiment of the present invention; and

FIG. 8 is a diagram illustrating an LEQ jitter minimum value (bottom jitter) of an optical recording medium according to a second verification example.

### DETAILED DESCRIPTION OF THE PREFERRED EMBODIMENTS

Embodiments according to the present invention will now be described with reference to the attached drawings.

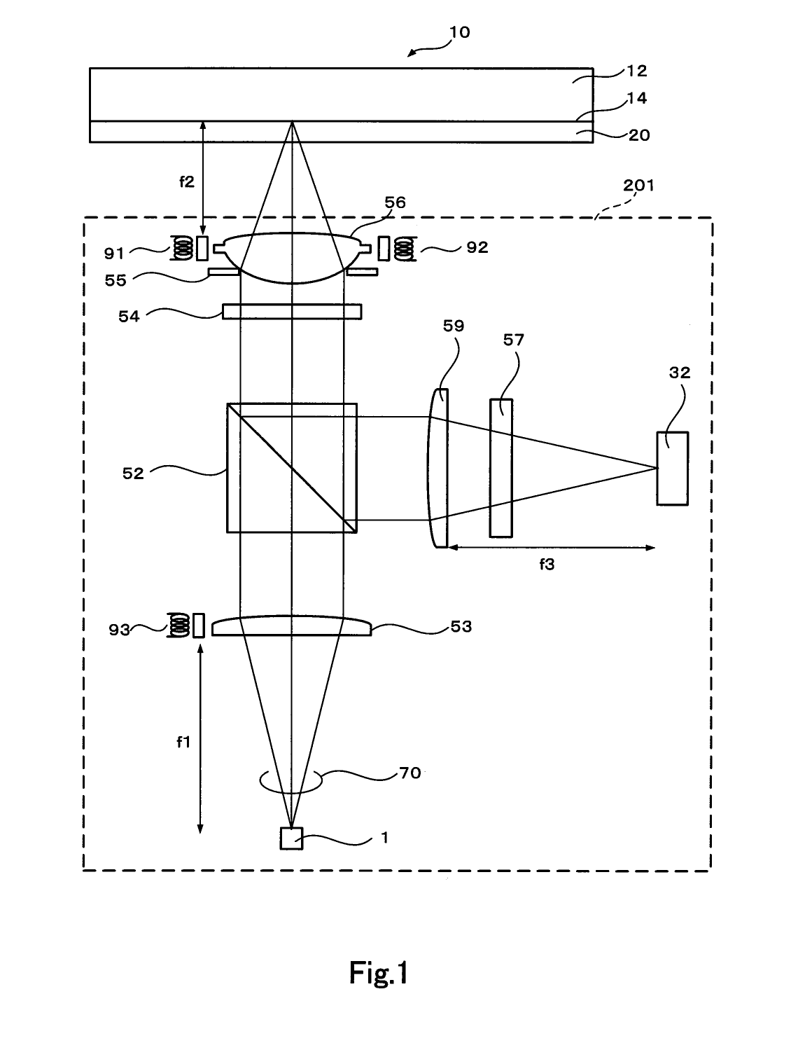

FIG. 1 illustrates the configuration of an optical recording medium 10 according to a first embodiment, and the configuration of an optical pickup 201 used in recording and reading performed on this optical recording medium. A divergent beam 7 output from a light source 1 having a wavelength of 380 to 450 nm (here, 405 nm) is transmitted through a collimating lens 53, which has a focal length f1 of 15 mm and which includes spherical aberration correction means 93, and is incident on a polarization beam splitter 52. The beam 70 incident on the polarization beam splitter 52 is transmitted through the polarization beam splitter 52, and then transmitted through a quarter-wave plate 54, whereby the beam is converted into a circularly-polarized light beam. This circularly-polarized light beam is then converted into a convergent beam by an objective lens 56 that has a focal length f2 of 2 mm. This beam is transmitted through a cover layer 20 of the optical recording medium 10, and concentrated on a recording and reading layer 14 formed between a support substrate 12 and the cover layer 20.

The opening of the objective lens 56 is limited by an aperture 55, and the numerical aperture NA is set to 0.70 to 0.90 (here, 0.85). The beam 70 reflected by the recording and reading layer 14 is transmitted through the objective lens 56 and the quarter-wave plate 54, converted into a linear polarized light beams that is 90° different from the outward path, and then reflected by the polarization beam splitter 52. The beam 70 reflected by the polarization beam splitter 52 is transmitted through a condenser 59 having a focal distance f3 of 10 mm, and converted into convergent light, which passes through a cylindrical lens 57 and is incident on a light detector 32. The beam 70 is made astigmatic when it passes through the cylindrical lens 57.

The light detector 32 has four not-illustrated light receiving units, and outputs a current signal based on the light amount received by each unit. Based on these current signals, for example, a focus error (hereinafter, “FE”) signal is generated by an astigmatic method, a tracking error (hereinafter, “TE”) signal is generated by a push pull method, and a reading signal about the information recorded in the optical recording medium 10 is generated. The FE and TE signals are amplified to a desired level and phase compensated to be fed back to the actuators 91 and 92, thereby achieving focusing and tracking controls.

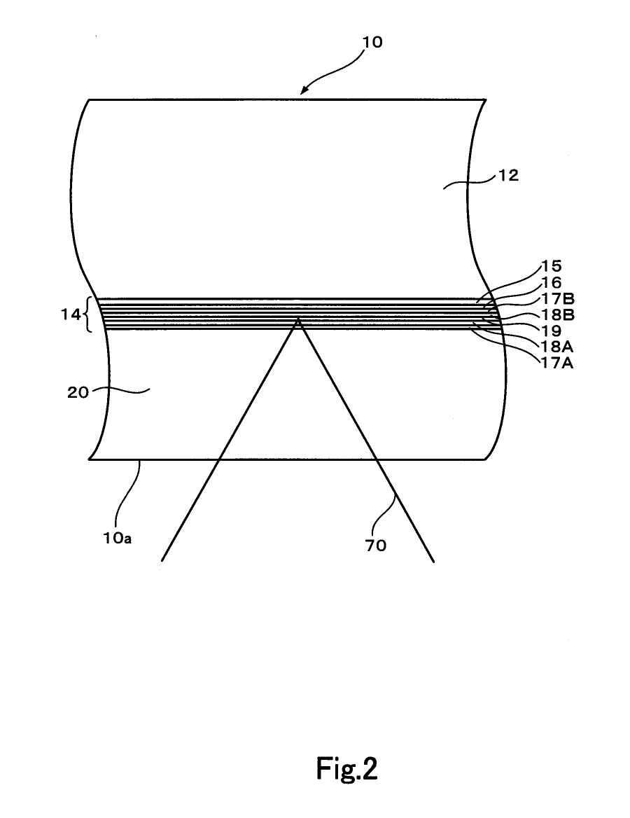

FIG. 2 is an enlarged view of the cross-sectional layer structure of the optical recording medium 10 according to the first embodiment. The optical recording medium 10 has a disc shape with an outer diameter of approximately 120 mm and a thickness of approximately 1.2 mm. This optical recording medium 10 is composed of, from an incident light surface 10a side, the cover layer 20, the recording and reading layer 14, and the support substrate 12. Further, information can be recorded on the recording and reading layer 14. Examples of the recording and reading layer 14 include a write-once recording and reading layer, which allows information to be written thereon only once and not rewritable, and a rewritable recording and reading layer, which allows the rewriting of information. However, here, a write-once recording and reading layer will be used as an example.

The support substrate 12, which is a substrate for ensuring the thickness (approximately 1.2 mm) that is required to serve as an optical recording medium, has a disc shape with a thickness of 1.1 mm and a diameter of 120 mm. Grooves and lands for guiding the beam 70 are formed in a spiral shape on the surface on the incident light side from the vicinity of the center of the surface toward the outer periphery thereof. Various materials may be used as the material for the support substrate 12, and examples thereof include a glass, a ceramic, and a resin. Among these, from the perspective of ease of molding, a resin is preferred. Examples of the resin include a polycarbonate resin, an olefin resin, an acrylic resin, an epoxy resin, a polystyrene resin, a polyethylene resin, a polypropylene resin, a silicone resin, a fluororesin, an ABS resin, and a urethane resin. Among these, from a perspective of such as workability, a polycarbonate resin, and an olefin resin are especially preferred. The support substrate 12 does not have to have a high light transmittance, since the support substrate 12 does not act as a light path for the beam 70. In the present embodiment, the pitch of the groove and land is 0.32 μm. Although the thickness of the support substrate 12 is not especially limited, the thickness thereof is preferably in the range of 0.05 to 2.4 mm. If the thickness is less than 0.05 mm, it becomes difficult to mold the substrate due to its low strength. On the other hand, if the thickness is more than 2.4 mm, the mass of the optical recording medium 10 increases, which makes it more difficult to handle. Although the shape of the support substrate 12 is also not especially limited, usually it is a disc shape, a card shape, or a sheet shape.

The recording and reading layer 19 formed on the support substrate 12 is configured by stacking, in order from the support substrate 12 side, a reflection film 15, a barrier layer 16, a second dielectric film 17B, a second Si recording layer 18B, a Ti recording layer 19, a first Si recording layer 18A, and a first dielectric film 17A.

An alloy having Ag as a main component is used for the reflection film 15. Here, an Ag—Nd—Cu alloy is used. The thickness of the reflection film 15 is preferably set, for example, between 5 to 300 nm, and especially preferably 20 to 200 nm. If the thickness of the reflection film 15 is less than 5 nm, a reflection function cannot be sufficiently obtained. On the other hand, if the thickness of the reflection film 15 is more than 300 nm, the deposition time increases, and the production properties dramatically deteriorate. Therefore, if the thickness is set in the above range, a reflection function and sufficient production properties can both be achieved. In the present embodiment, the thickness of the reflection film 15 is set to 80 nm. Further, although Ag is used as the main component of the reflection film 15 here, an alloy having Al as a main component may also be used.

The barrier layer 16 is a protective film for suppressing sulfuration of the metals, such as Ag, included in the reflection film 15. An alloy having ZnO as a main component is used for the barrier layer 16. Here, a ZnO—SnO—InO alloy is used. In the present embodiment, the thickness of the barrier layer 16 is set to 5 nm. Depending on the components included in the reflection film 15, this barrier layer 16 can be omitted.

In addition to the basic function of protecting the second Si recording layer 18B and the first Si recording layer 18A, the second dielectric film 17B and the first dielectric film 17A also have a function for enlarging a difference in the optical properties (degree of modulation) before and after the formation of a recording mark. To increase the difference in optical properties before and after recording mark formation, it is preferred to select as the material for the first and second dielectric films 17A and 173 a material having a high refractive index (n) in the wavelength region of the beam 70 that is used, specifically, the wavelength region of 380 nm to 450 nm (especially, 405 nm). Further, when the beam 70 is irradiated, if the energy that is absorbed by the first and second dielectric films 17A and 17B is large, the recording sensitivity tends to deteriorate. Accordingly, to prevent this phenomenon, it is preferred to select a material having a low absorption coefficient (k) in the wavelength region of 380 to 450 nm (especially, 405 nm) as the material for the first and second dielectric films 17A and 17B. In the present embodiment, a mixture of a sulfide and an oxide is used as the material for the first and second dielectric films 17A and 17B. More specifically, a mixture of ZnS and SiO₂ (mole ratio 80:20) is used.

Further, other materials may also be employed for the first and second dielectric films 17A and 17B, as long as such materials are a transparent dielectric material. Examples thereof include a dielectric material having an oxide, a sulfide, a nitride, or a combination thereof as a main component. It is preferred to include as a main component at least one kind of dielectric material selected from the group consisting of Al₂O₃, AlN, ZnO, ZnS, GeN, GeCrN, CeO, SiO, SiO₂, SiN, and SiC.

Further, considering the fact that the wavelength of the beam 70 is in the blue light wavelength region of 380 nm to 450 nm, it is preferred that the thickness of the first and second dielectric films 17A and 17B is 3 to 200 nm. If the thickness is less than 3 nm, it is difficult to obtain the function for protecting the second Si recording layer 18B, and the function for enlarging the difference in optical properties before and after recording mark formation. On the other hand, if the thickness is more than 200 nm, the deposition time increases, and the productivity may deteriorate. Here, the thickness of the second dielectric film 17B is set to 13.75 nm and the thickness of the first dielectric film 17A is set to 18 nm.

The second Si recording layer 18B, the Ti recording layer 19, and the first Si recording layer 18A are films onto which a recording mark is irreversibly formed due to these three layers interacting with each other. The second Si recording layer 18B, the Ti recording layer 19, and the first Si recording layer 18A are stacked adjacent to each other. When the beam 70 having a predetermined power or greater power is irradiated, the three layers are chemically or physically modified simultaneously by the heat from the beam, whereby the reflectivity of that region is changed. Although the cause of the change in reflectivity is unclear, it is speculated that the reflectivity changes due to the elements in the three layers, the second Si recording layer 18B, the Ti recording layer 19, and the first Si recording layer 18A, intermingling with each other either partially or totally at the surfaces where the layers contact each other. Consequently, the reflectivity with respect to the beam 70 at the portions where a recording mark is formed is very different from that at other portions (blank regions). As a result, data recording and reading can be achieved.

The material used for the first and second Si recording layers 18A and 18B includes silicon (Si) as a main component. In the present embodiment, an example is illustrated in which the first and second Si recording layers 18A and 18B are configured from only Si. Further, Ge, Sn, Mg, In, Zn, Bi, Al and the like may also be included as addition elements.

The thickness T1 of the first Si recording layer 18A is set to 0 nm<T1≦10 nm, preferably 0 nm<T1≦8.5 nm, and more preferably 4 nm≦T1≦8 nm. In the present embodiment, the thickness T1 of the first Si recording layer 18A is set to 6 nm.

The thickness T2 of the second Si recording layer 18B is set to 0 nm≦T2≦8 nm, preferably 0 nm≦T2≦4 nm, and more preferably 1 nm≦T2≦3 nm. In the present embodiment, the thickness T2 of the second Si recording layer 18B is set to 2 nm.

As can be seen from the above numerical ranges, in the present embodiment it is preferred to set the thickness so that T1>T2. The specific basis for these numerical ranges will be described below in the first verification example.

The material used for the Ti recording layer 19 has Ti as a main component. Specifically, a material having a Ti—Al composition formed by adding Al to Ti (Ti being as the main component) is employed. More specifically, it is preferred to add, based on the Ti, Al in the range of 25 atm % to 50 atm %. In the present embodiment, the Ti:Al ratio is set to 68:32 (atm %). Further, one element or two or more elements, such as Zn, Ni, Mg, Al, Ag, Au, Si, Sn, Ge, P, Cr, and Fe, may be added as an added material.

Although the thickness T3 of the Ti recording layer 19 is not especially limited, it is preferred to set the thickness to 5.5 nm≦T3≦9.25 nm, and more preferably 5.5 nm≦T3≦9 nm. In the present embodiment, the thickness T3 is set to 7.5 nm.

Further, the term “main component” in the present embodiment means that the content of that material is larger than any of the other components, or is included in an atom ratio or a mole ratio of 50% or more.

The cover layer 20 is provided for protecting the recording and reading layer 14, and is made of a light-transmitting acrylic UV-curable resin. Although the thickness of the cover layer 20 is not especially limited, it is preferably 1 to 200 μm. In the present embodiment, the thickness is set to 100 μm. If the thickness of the cover layer 20 is less than 1 μm, it is difficult to protect the recording and reading layer 14. On the other hand, if the thickness of the cover layer 20 is more than 200 μM, it is difficult to control the thickness of the cover layer 20 and difficult to ensure the machine accuracy of the whole optical recording medium 10.

When recording information is performed on the above optical recording medium 10, as illustrated in FIG. 2, the intensity-modulated beam 70 is caused to be incident on the optical recording medium 10 from the incident light surface 10a side of the cover layer 20, so as to be irradiated on the recording and reading layer 14. When the beam 70 is irradiated on the recording and reading layer 14, the recording and reading layer 14 is thereby heated, and the respective elements (Si, Ti, Si) constituting the second Si recording layer 18B, the Ti recording layer 19, and the first Si recording layer 18A intermingle among each other. This mixed portion becomes a recording mark, whose reflectivity is a different value from the reflectivity of the other portions (blank regions).

Next, the method for manufacturing the optical recording medium 10 according to the present embodiment will be described.

First, the support substrate 12 formed with grooves and lands is produced by injection molding using a stamper. However, production of the support substrate 12 is not limited to the injection molding method. A 2P method or some other method may also be used.

Next, the reflection film 15 is formed on the surface of the support substrate 12 on the side provided with the grooves and lands. This reflection film 15 can be formed by vapor-phase epitaxy that utilizes a chemical species including silver (Ag) as a main component, for example, a sputtering method or a vacuum deposition method. It is especially preferred to use a sputtering method. Subsequently, the barrier layer 16 is formed on the reflection film 15. It is also preferred to use vapor-phase epitaxy for the formation of the barrier layer 16. In addition, a vapor-phase epitaxy method utilizing a chemical species including a sulfide, an oxide, a nitride, a carbide, a fluoride or a mixture thereof may also be employed during the formation of the second dielectric film 17B on the barrier layer 16. Of these, it is preferred to use a sputtering method.

Next, the second Si recording layer 18B, the Ti recording layer 19, and the first Si recording layer 18A are formed on the second dielectric film 17B. These layers may also be formed by vapor-phase epitaxy, among which methods it is preferred to use a sputtering method.

Next, the first dielectric film 17A is formed on the first Si recording layer 18A. Similar to the second dielectric film 17B, the first dielectric film 17A is formed by vapor-phase epitaxy utilizing a chemical species including a sulfide, an oxide, a nitride, a carbide, a fluoride or a mixture thereof, which are preferable main components. Among such methods, it is preferred to use a sputtering method.

Lastly, the cover layer 20 is formed on the first dielectric film 17A. The cover layer is formed by applying a viscosity-adjusted acrylic or epoxy UV curable resin over the film 17A by spin coating, and then irradiating UV rays thereon to cure the resin. Further, instead of a UV curable resin, the cover layer 20 may also be formed by sticking a light-transmitting sheet formed from a light-transmitting resin onto the first dielectric film 17A using a bonding agent or a pressure-sensitive adhesive.

Although the above manufacturing method was described for the present embodiment, the present invention is not especially limited to the above-described manufacturing method. Other manufacturing techniques may also be employed.

The optical recording medium 10 according to the present embodiment includes, as the recording and reading layer 14, the Ti recording layer 19, the first Si recording layer 18A arranged adjacent to the cover layer 20 side of this Ti recording layer 19, and the second Si recording layer 18B arranged adjacent to the support substrate 12 side of the Ti recording layer 19. By employing this three-layer structure, the jitter during reading and the power margin property when recording information are improved.

Further, by setting the thickness T1 of the first Si recording layer 18A to be 0 nm≦T1≦8.5 nm and the thickness T2 of the second Si recording layer 18B to be 0 nm≦T2≦9 nm, the jitter during reading can be reduced while suppressing the optimum recording power to be as small as possible. In particular, by setting the thickness T1 of the first Si recording layer 18A to be 4 nm≦T1≦8 nm and the thickness T2 of the second Si recording layer 18B to be 1 nm≦T2≦3 nm, bottom jitter can be favorably improved.

### First Verification Example

Based on the optical recording medium 10 according to the first embodiment, 100 media combinations were manufactured by varying the thickness of the second Si recording layer 18B in 1 nm steps between 0 nm to 10 nm while simultaneously varying the thickness of the first Si recording layer 18A in 1 nm steps between 0 nm to 10 nm. The recording and reading properties of these media were verified.

Specifically, information was recorded onto the optical recording medium 10 while varying the recording power, and the signal properties during the reading of this information were evaluated in terms of reflectivity, degree of modulation, bottom jitter, and power margin. An LEQ (limit equalizer) was used for the jitter evaluation. In the evaluation of the power margin, the recording power at which the LEQ jitter is at a minimum (bottom jitter) is defined as the optimum recording power Po (Pₒₚₜᵢₘᵤₘ), and the actual recording power is defined as Pw. Further, Pw/Po is used as the power margin. In particular, in this verification, the recording power Pw was varied in both the strong and weak directions, and the power values at the times at which the LEG jitter exceeded 10% were taken as the minimum recording power P_{under} and the maximum recording power Pₒᵥₑᵣ, and (P_{under}−Pₒᵥₑᵣ) was employed as the power margin value.

Further, the evaluation was carried out using an optical disc evaluation apparatus ODU-1000 (NA=0.85, λ=405 nm) manufactured by Pulstec Industrial Co., Ltd., under recording conditions of a modulation signal of (1, 7) RLL, a linear velocity during recording of 9.84 m/s, and a linear velocity during reading of 4.92 m/s.

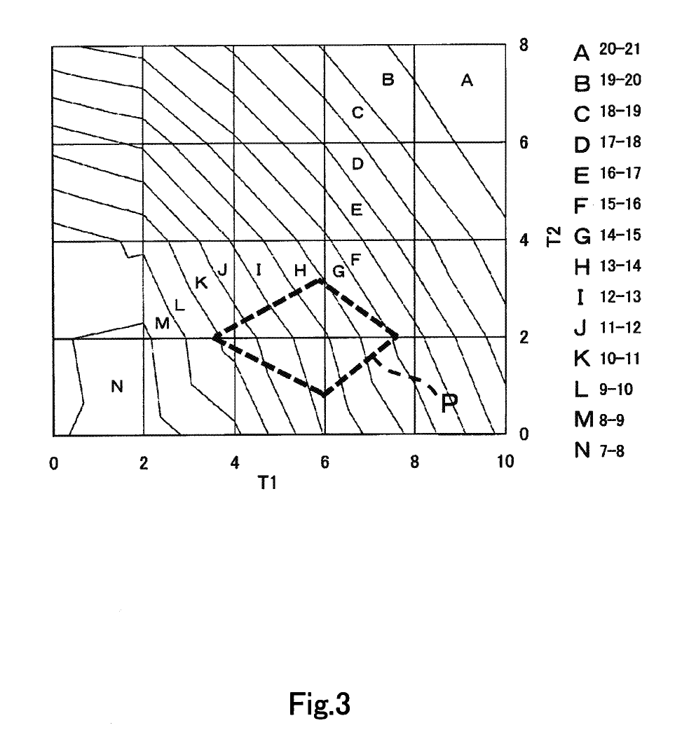

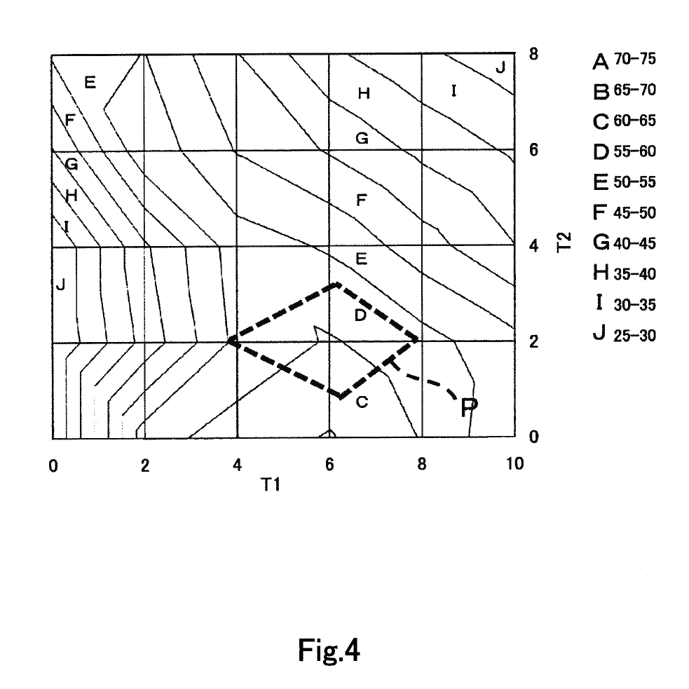

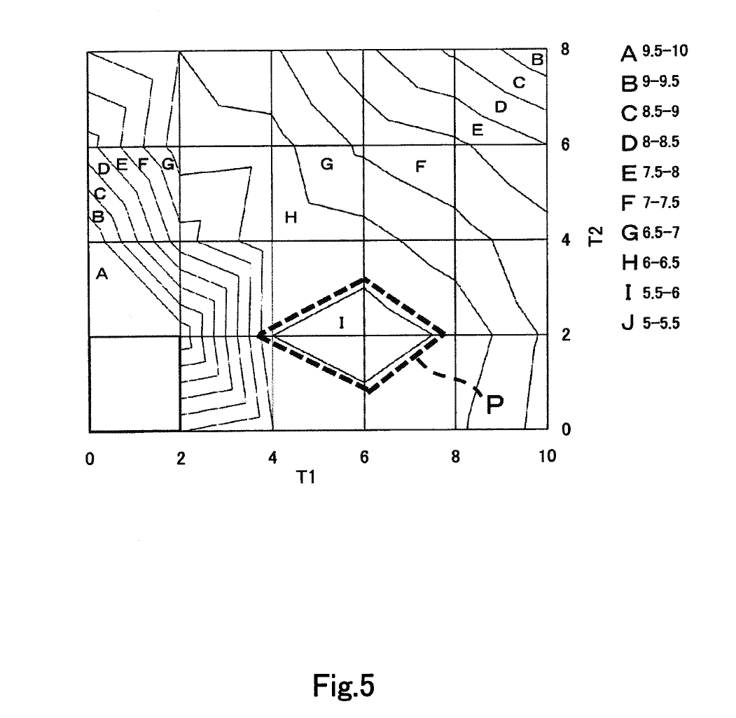

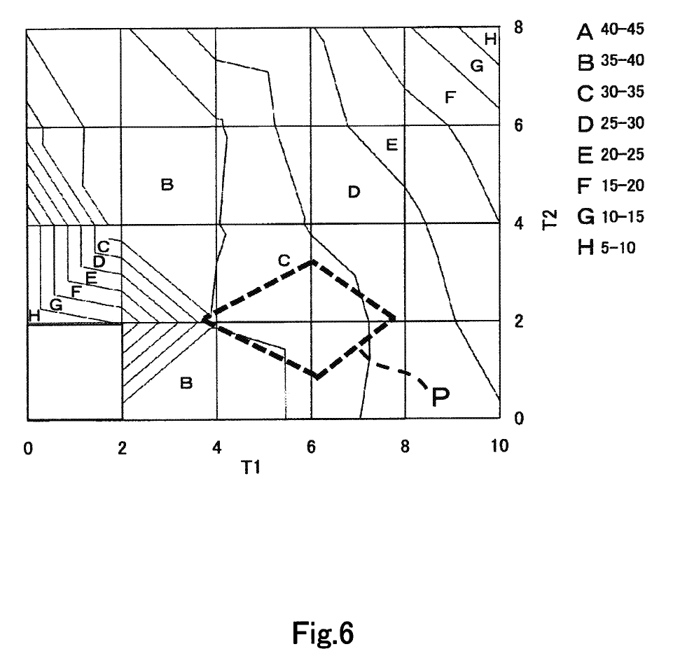

As the evaluation results, the reflectivity of an unrecorded state is shown in FIG. 3, the degree of modulation during the use of the optimum recording power Po is shown in FIG. 4, the minimum value of LEQ jitter (bottom jitter) is shown FIG. 5, and the power margin is shown in FIG. 6. Analysis was carried out by mapping the verification results as contour lines on a matrix with the thickness T1 of the first Si recording layer 18A on the horizontal axis and the thickness T2 of the second Si recording layer 18B on the vertical axis.

It can be seen from the unrecorded state reflectivity illustrated in FIG. 3 that the region in which the reflectivity is preferable 10% or more, specifically, the region from A to K, spreads out toward the right and upper right sides in the map. More specifically, it can be seen that in the region in which the thickness T1 of the first Si recording layer 18A is 3 to 4 nm or more, a sufficient reflectivity can be obtained. Further, it can also be seen that an even better reflectivity can be obtained if the thickness T2 of the second Si recording layer 18B is thick. In particular, it is preferred that the thickness Ti of the first Si recording layer 18A is 4 nm or more and the thickness T2 of the second Si recording layer 18B is 1 nm or more, because a stable and sufficient reflectivity of 10% or more can be obtained.

From FIG. 4, it can be seen that the region in which the degree of modulation is preferable 55% or more, specifically, the region from A to D, spreads out toward the lower right side in the map. Specifically, a sufficient degree of modulation can be obtained in the region in which the thickness T2 of the second Si recording layer 18B is 4 nm or less, preferably 3 nm or less, and the thickness T1 of the first Si recording layer 18A is 4 nm or more and 8 nm or less. More specifically, from a degree of modulation perspective, the conditions of 4 nm≦T1≦8 nm and T2≦3 nm can elicit preferable effects.

From FIG. 5, it can be seen that the region in which bottom jitter is preferable 7% or less, specifically, the region of G, H, I, and J, spreads out toward the lower right side in the map. In particular, according to this verification, it can be seen that the region in which bottom jitter is more preferable 6% or less, specifically, the region of I and J, partially spreads out like a floating island toward the lower right side in the map. Specifically, a sufficient bottom jitter can be obtained in the region in which the thickness T2 of the second Si recording layer 18B is 1 nm or more and 3 nm or less and the thickness T1 of the first Si recording layer 18A is 4 nm or more and 8 nm or less. More specifically, from a bottom jitter perspective, the conditions of 4 nm≦T1≦8 nm and 1 nm≦T2≦3 nm can elicit preferable effects.

From FIG. 6, it can be seen that the region in which the power margin is preferable 25% or more, specifically, the region from A to D, spreads out upwards and downwards from the center of the map. In particular, if the thickness T2 of the second Si recording layer 18B increases, the power margin property tends to deteriorate. Therefore, although the power margin is better with a smaller thickness T2 of the second Si recording layer 18B, in the region in which the thickness T2 of the second Si recording layer 18B is about 2 nm, if the thickness T1 of the first Si recording layer 18A is small, the power margin tends to locally deteriorate. Further, it can also be seen that this defect can be offset by setting the thickness T1 of the first Si recording layer 18A to 4 nm or more, even when the thickness T2 of the second Si recording layer 18B is about 2 nm, so that a stable power margin of 25% or more can be obtained. More specifically, the problem that arises when the thickness T2 of the second Si recording layer 18B is about 2 nm can be offset by compensating with the first Si recording layer 18A.

In FIGS. 5 and 6, the combined region of a first Si recording layer 18A thickness T1 of less than 2 nm and a second Si recording layer 18B thickness T2 of less than 2 nm is excluded from the evaluation target, since even the formation of the recording mark is unstable.

Region P, which satisfies the most preferable conditions of FIGS. 3 to 6, is superimposed on each of the drawings. For region P, it can be seen that the thickness T1 of the first Si recording layer 18A is set to 4 nm≦T1≦8 and the thickness T2 of the second Si recording layer 18B is set to 1 nm≦T2≦3 nm. Further, based on the overall verification results, it can also be seen that it is preferred to set the thickness T2 of the second Si recording layer 18B to be smaller than the thickness T1 of the first Si recording layer 18A.

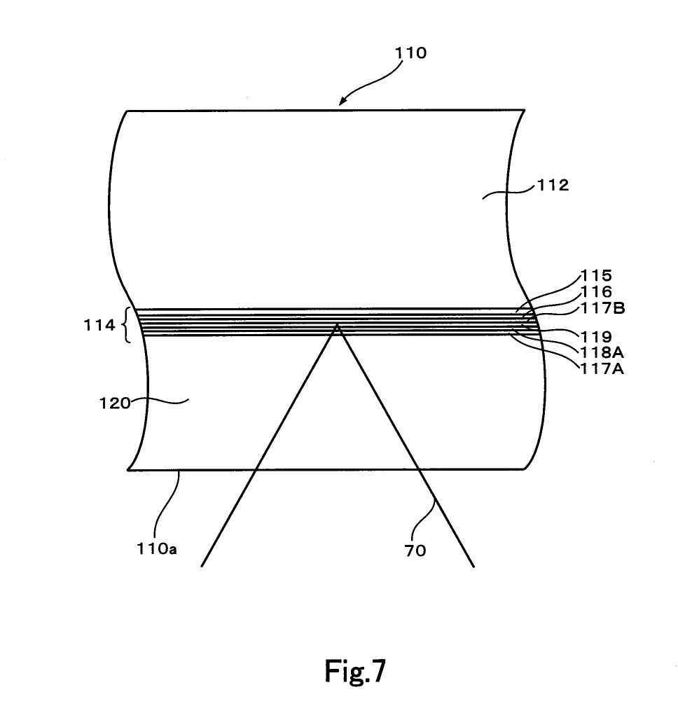

Next, an optical recording medium 110 according to a second embodiment of the present invention will be described with reference to the cross sectional layer structure of FIG. 7. Compared with the optical recording medium 10 of the first embodiment, a feature of this optical recording medium 110 is that it lacks the second Si recording layer. The rest of its structure is mainly the same as the optical recording medium 10 of the first embodiment. Therefore, parts in the optical recording medium 110 of the second embodiment that are the same or similar to the optical recording medium 10 of the first embodiment are denoted using the same last two digits, and a description of each of the parts is omitted.

This optical recording medium 110 is configured to include, from an incident light surface 110a side, a cover layer 120, a recording and reading layer 114, and a support substrate 112. The recording and reading layer 114 is a write-once recording and reading layer.

The recording and reading layer 114 formed on the support substrate 112 is configured by stacking, in order from the support substrate 112 side, a reflection film 115, a barrier layer 116, a second dielectric film 117B, a Ti recording layer 119, a first Si recording layer 118A, and a first dielectric film 117A.

The Ti recording layer 119 and the first Si recording layer 118A are films onto which a recording mark is irreversibly formed due to these two layers interacting with each other. The Ti recording layer 119 and the first Si recording layer 118A are stacked adjacent to each other. In this case, when the beam 70 having a predetermined or greater power is irradiated, the two layers are chemically or physically modified simultaneously by the heat from the beam, whereby the reflectivity of that region is changed. Although the cause of the change in reflectivity is unclear, it is speculated that the reflectivity changes due to the elements in the two layers, the Ti recording layer 119 and the first Si recording layer 118A, intermingling either partially or totally at the surfaces where the layers contact each other. Consequently, the reflectivity with respect to the beam 70 at the portions where a recording mark is formed is very different from that at other portions (blank regions). As a result, data recording and reading can be performed.

The thickness T1 of the first Si recording layer 118A is set to 0 nm<T1≦10 nm, preferably 0 nm<T1≦8.5 nm, and more preferably 4 nm≦T1≦8 nm. Further, to form the first Si recording layer 118A as a single layer as in the second embodiment, it is preferred to set the thickness T1 to 5.5 nm or more. In the second embodiment, the thickness T1 of the first Si recording layer 118A is set to 8 nm.

Although the thickness T3 of the Ti recording layer 119 is not especially limited, it is preferred to set the thickness to 5.5 nm≦T3≦9.25 nm, and more preferably 5.5 nm≦T3≦9 nm. Here, the thickness T3 is set to 7.5 nm.

When recording information on the optical recording medium 110, as illustrated in FIG. 7, the intensity-modulated beam 70 is caused to be incident on the optical recording medium 110 from the incident light surface 110a side of the cover layer 120, to as to be irradiated on the recording and reading layer 114. When the beam 70 is irradiated on the recording and reading layer 114, the recording and reading layer 114 is heated, and the respective elements (Ti, Si) constituting the Ti recording layer 119 and the first Si recording layer 118A intermingle among each other. This mixed portion becomes a recording mark, whose reflectivity is a different value from the reflectivity of the other portions (blank regions).

The optical recording medium 110 of the second embodiment employs, as the recording and reading layer 114, a two-layer structure formed from the Ti recording layer 119 and the first Si recording layer 118A arranged adjacent to the cover layer 20 side of this Ti recording layer 119. By employing this two-layer structure, the jitter during reading and the power margin property when recording information are improved.

### Second Verification Example

Based on the above optical recording medium 110 of the second embodiment, media combinations were manufactured by varying the thickness T3 of the Ti recording layer 119 in 1 nm steps between 5.5 nm to 9.25 nm while simultaneously varying the thickness T1 of the first Si recording layer 118A in 1 nm steps between 4 nm to 18.5 nm. The recording and reading properties of these media were evaluated.

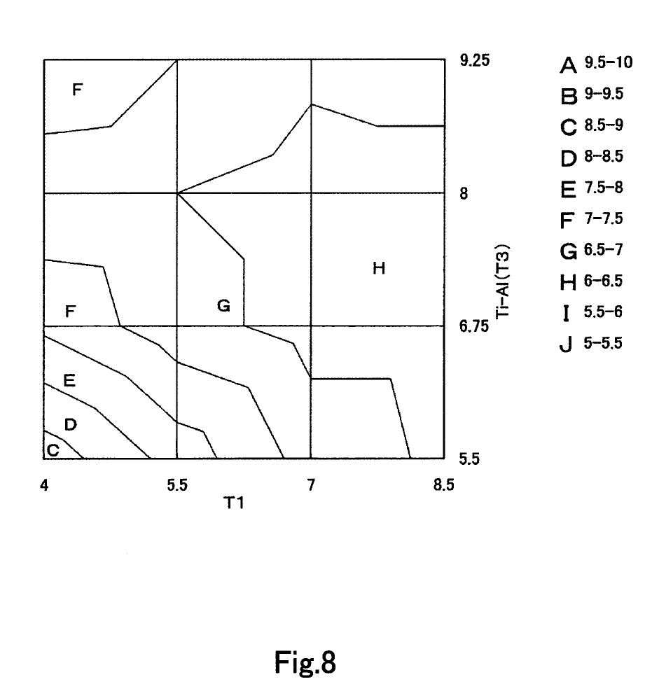

The verification method was carried out in the same manner as the first verification example. In this verification, LEQ bottom jitter was evaluated. The evaluation results are shown in FIG. 8.

From FIG. 8, it can be seen that the region in which bottom jitter is preferable 7% or less, specifically, the region of G, H, I, and J, spreads out toward the center on the right side in the map. In particular, according to this verification, it can be seen that bottom jitter is good in the region in which the thickness T3 of the Ti recording layer 119 is in the range of 5.5 nm≦T3≦9 nm, and that bottom jitter is even better in the region in the range of 6.75 nm≦T3≦9 nm. Further, it can also be seen that bottom jitter improves more when the greater thickness T1 of the first Si recording layer 118A is. Especially, stable bottom jitter can be obtained in the region of T1≧5.5 nm.

Although the optical recording media 10 and 110 according to the first and second embodiments were described for a write-once optical recording medium, the present invention may also be applied in optical recording media that employ other recording methods. However, when applying in a rewritable optical recording medium, the recording and reading layer needs to be preheated so that the whole structure is crystallized. On the other hand, since the present invention has the advantage of enabling a recording mark to be directly formed without undergoing such a step, it can be said that it is preferable to apply the present invention in a write-once optical recording medium.

Further, although the optical recording media 10 and 110 according to the above embodiments include a single recording film configured from a Ti recording layer and a Si recording layer arranged on both sides or one side of the Ti recording layer, as long as the gist of the present invention is satisfied, a recording layer formed from other materials may be provided near this layer structure.

In addition, in the above embodiments, although only a case in which the wavelength region of the beam 70 used in optical recording and reading is 380 nm to 450 nm was described, the present invention is not limited to this. The wavelength region is, for example, preferably 250 nm to 900 nm.

Moreover, in the present embodiments, although only a case in which the recording and reading layer is a single layer was described, the present invention is not limited to this. For example, a plurality of recording and reading layers may be provided. In such a case, it is preferred that all of the recording and reading layers have a Si recording layer arranged on both sides or one side of a Ti recording layer.

The optical recording medium according to the present invention is not limited to the above-described embodiments. Obviously, various changes may be carried out as long as such changes do not depart from the gist of the present invention.

The optical recording medium according to the present invention can be applied in various optical recording media including a multilayer structure.

The entire disclosure of Japanese Patent Application No. 2010-110825 filed on May 13, 2010 including specification, claims, drawings, and summary are incorporated herein by reference in its entirety.

What is claimed is:

1. An optical recording medium comprising:
a substrate;
a cover layer;
a Ti recording layer that is arranged between the substrate and the cover layer and includes Ti as a main component and Al as an addition component; and
a first Si recording layer that is arranged adjacent to a cover layer side of the Ti recording layer and includes Si as a main component.

2. The optical recording medium according to claim 1, wherein the first Si recording layer has a thickness T1 that is set to 4 nm≦T1≦8 nm.

3. The optical recording medium according to claim 1 or 2, further comprising a second Si recording layer that is arranged adjacent to a substrate side of the Ti recording layer and includes Si as a main component.

4. The optical recording medium according to claim 3, wherein the second Si recording layer has a thickness T2 that is set to 1 nm≦T2≦3 nm.

5. The optical recording medium according to claim 3, wherein a thickness T2 of the second Si recording layer is set to be smaller than the thickness T1 of the first Si recording layer.

6. The optical recording medium according to claim 4, wherein the thickness T2 of the second Si recording layer is set to be smaller than the thickness T1 of the first Si recording layer.

7. The optical recording medium according to claim 3, further comprising:
a first dielectric layer that is arranged adjacent to a cover layer side of the first Si recording layer, and
a second dielectric layer that is arranged adjacent to a substrate side of the second Si recording layer.

8. The optical recording medium according to claim 4, further comprising:
a first dielectric layer that is arranged adjacent to a cover layer side of the first Si recording layer, and
a second dielectric layer that is arranged adjacent to a substrate side of the second Si recording layer.

9. The optical recording medium according to claim 5, further comprising:
a first dielectric layer that is arranged adjacent to a cover layer side of the first Si recording layer, and
a second dielectric layer that is arranged adjacent to a substrate side of the second Si recording layer.

10. The optical recording medium according to claim 6, further comprising:
a first dielectric layer that is arranged adjacent to a cover layer side of the first Si recording layer, and
a second dielectric layer that is arranged adjacent to a substrate side of the second Si recording layer.

11. An optical recording method for recording information by irradiating a laser beam on an optical recording medium having a substrate, a cover layer, and an information recording layer between the substrate and the cover layer, the method comprising:
providing, as the information recording layer, a Ti recording layer that includes Ti as a main component and Al as an addition component, and a first Si recording layer that is arranged adjacent to the cover layer side of the Ti recording layer and includes Si as a main component; and
chemically or physically modifying the Ti recording layer and the first Si recording layer simultaneously by heat from the laser beam.

12. The optical recording method according to claim 11, wherein:
the information recording layer further includes a second Si recording layer that is arranged adjacent to the substrate side of the Ti recording layer and includes Si as a main component; and
the Ti recording layer, the first Si recording layer, and the second Si recording layer are chemically or physically modified simultaneously by heat from the laser beam.
